(19) United States
(12) Patent Application Publication
(10) Pub. No.: US 2020/0238453 A1
(43) Pub. Date: Jul. 30, 2020

(54) SCREW DISASSEMBLY DEVICE

(71) Applicants: FOXCONN PRECISION ELECTRONICS (TAIYUAN) CO., LTD., Taiyuan (CN); HON HAI PRECISION INDUSTRY CO., LTD., New Taipei (TW)

(72) Inventors: RONG-YUN SUN, Shenzhen (CN); YUE MU, Taiyuan (CN); FEN-LONG SONG, Taiyuan (CN); KAI-TAO JIN, Zhengzhou (CN)

(73) Assignees: FOXCONN PRECISION ELECTRONICS (TAIYUAN) CO., LTD., Taiyuan (CN); HON HAI PRECISION INDUSTRY CO., LTD., New Taipei (TW)

(21) Appl. No.: 16/658,505

(22) Filed: Oct. 21, 2019

(30) Foreign Application Priority Data
Jan. 25, 2019 (CN) 201910073088.2

(51) Int. Cl. B23P 19/06; F04D 17/16; B25B 23/02

(52) U.S. Cl. CPC B23P 19/06; B25B 23/02; F04D 17/168

(57) ABSTRACT

A screw disassembly device includes a driving mechanism, an electric screwdriver, and a collecting mechanism. The driving mechanism is coupled to the electric screwdriver to drive the electric screwdriver to move. The electric screwdriver disassembles a screw and includes a head portion. The head portion adsorbs the screw. The collecting mechanism includes a stripping member, a transfer block, and a receiving box. The transfer block is mounted on the driving mechanism. The transfer block defines a transfer chamber. The head portion movably passes through the transfer block and the transfer chamber. The stripping member clamps the screw within the transfer chamber to remove the screw from the head portion. An inner chamber of the receiving box is coupled to the transfer chamber by the transfer tube. The receiving box generates a negative pressure to suck the screw through the transfer tube into the receiving box.

### FIELD

The subject matter herein generally relates to a screw disassembly device, and more particularly to a screw disassembly device and a collecting mechanism of the screw disassembly device.

### BACKGROUND

Generally, during a process of disassembling a plurality of screws, the screws need to be collected. When the screws are very small and numerous, some of the screws are easy to lose.

### BRIEF DESCRIPTION OF THE DRAWINGS

Implementations of the present disclosure will now be described, by way of embodiments, with reference to the attached figures.

FIG. 1 is an assembled, isometric view of an embodiment of a screw disassembly device.

FIG. 2 is similar to FIG. 1, but showing the screw disassembly device from another angle.

FIG. 3 is a cross-sectional view of a collecting mechanism of the screw disassembly device.

FIG. 4 is a partial exploded view of the collecting mechanism.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

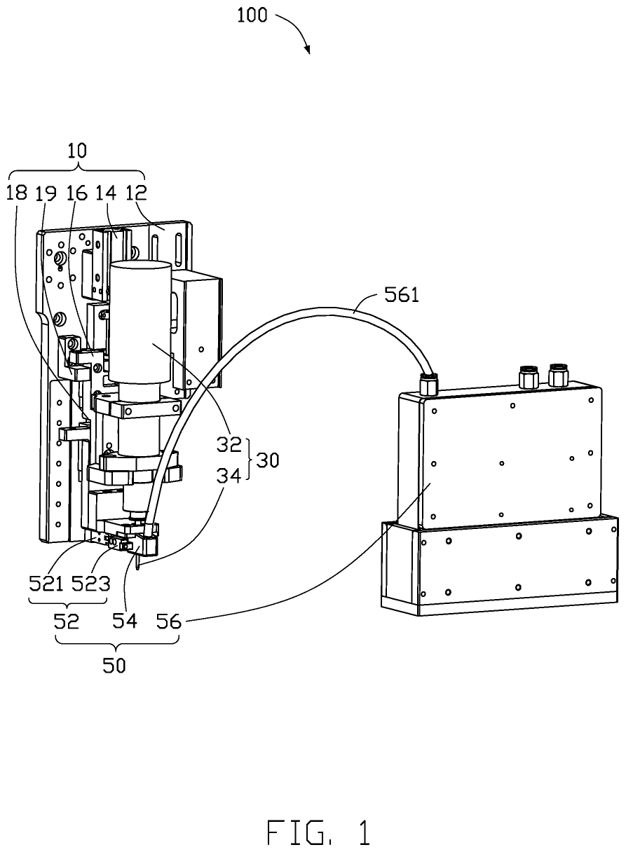

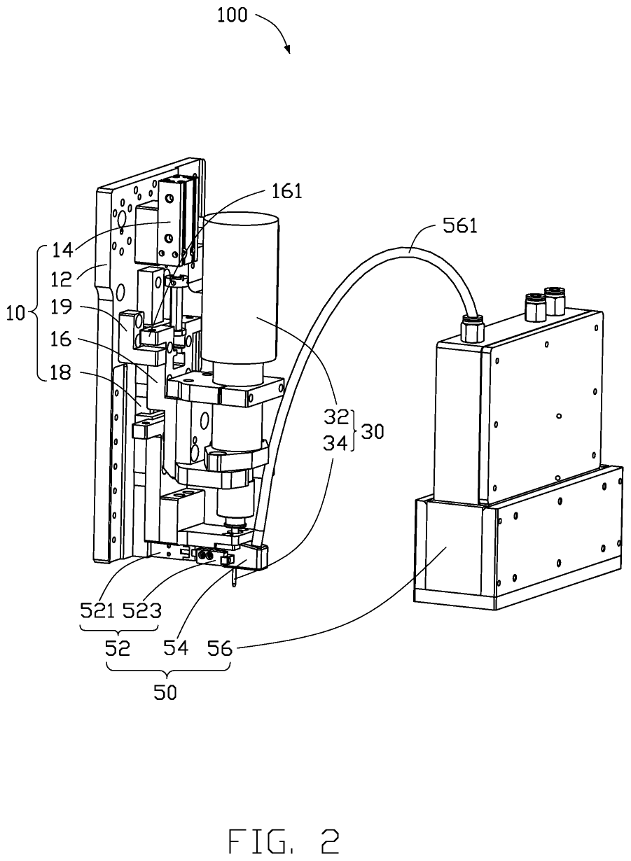

Referring to FIGS. 1 and 2, a screw disassembly device 100 includes a driving mechanism 10, an electric screwdriver 30, and a collecting mechanism 50. The driving mechanism 10 may be disposed above a conveying line (not shown). The electric screwdriver 30 is mounted on the driving mechanism 10. The driving mechanism 10 drives the electric screwdriver 30 to move toward or away from the conveyor line. The electric screwdriver 30 is configured to disassemble a screw from a workpiece on the conveying line. The collecting mechanism 50 is mounted on the driving mechanism 10 and adjacent to an end of the electric screwdriver 30. The collecting mechanism 50 is configured to collect the screws that are disassembled by the electric screwdriver 30.

The driving mechanism 10 includes a mounting plate 12, a mobile driving member 14, and a connecting block 16. The mounting plate 12 is disposed above the conveying line. The mobile driving member 14 is mounted on the mounting plate 12. The connecting block 16 is mounted on an output shaft (not shown) of the mobile driving member 14. The electric screwdriver 30 is mounted on the connecting block 16. The mobile driving member 14 drives the electric screwdriver 30 to move toward or away from the conveyor line.

In one embodiment, the driving mechanism 10 further includes a sliding rail 18. The sliding rail 18 is mounted on the mounting plate 12. The connecting block 16 is slidably mounted on the sliding rail 18. In other embodiments, the sliding rail 18 can be omitted.

In one embodiment, the connecting block 16 includes at least one protruding portion 161, and the driving mechanism 10 further includes at least one stopping block 19. The at least one stopping block 19 is mounted on the mounting plate 12. The stopping block 19 blocks the protruding portion 161 to limit a maximum course of movement of the electric screwdriver 30.

In other embodiments, the driving mechanism 10 may be attached to a robot or other device to operate the driving mechanism 10.

The electric screwdriver 30 includes a main body 32 and a head portion 34 mounted on the main body 32. The main body 32 is mounted on the connecting block 16. The main body 32 drives the head portion 34 to rotate to disassemble the screw. In one embodiment, the head portion 34 is a magnetic member capable of adsorbing the screw.

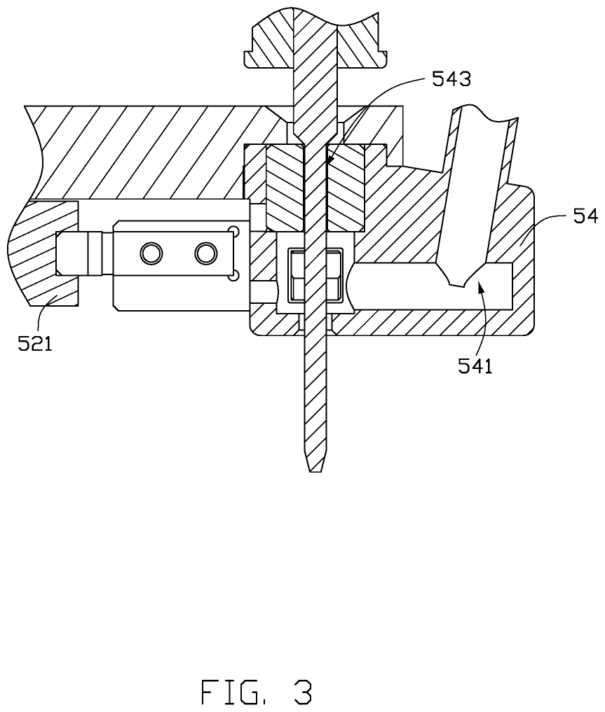

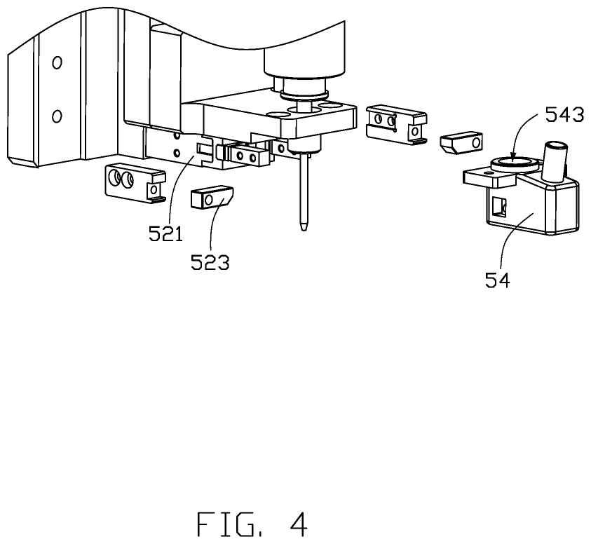

Referring to FIG. 3 and FIG. 4, the collecting mechanism 50 includes a stripping member 52, a transfer block 54, and a receiving box 56. The transfer block 54 is mounted on the mounting plate 12 below the electric screwdriver 30. The transfer block 54 defines a transfer chamber 541 and a clearance hole 543 in communication with the transfer chamber 541. The clearance hole 543 extends through opposite sides of the transfer block 54. The head portion 34 is configured to pass through the clearance hole 543 through the transfer block 54 to disassemble the screw or move the disassembled screw into the transfer chamber 541 through the clearance hole 543.

The stripping member 52 includes a stripping driving member 521 and two clamping blocks 523. The stripping driving member 521 is mounted on the mounting plate 12. One end of each of the two clamping blocks 523 is mounted to the stripping driving member 521, and a second end of each of the two clamping blocks 523 is movably inserted into the transfer block 54 and respectively located on opposite sides of the clearance hole 543. The stripping driving member 521 drives the two clamping blocks 523 to move toward each other to clamp the screw at an end of the head portion 34 to separate the screw from the head portion 34 and drives the two clamping blocks 523 to move away from each other to release the screw.

An inner chamber (not shown) of the receiving box 56 communicates with the transfer chamber 541 through a transfer tube 561. The receiving box 56 is coupled to a vacuum generator (not shown) to generate a negative pressure in the inner chamber of the receiving box 56 to suck the screw into the receiving box 56 through the transfer tube 561.

In one embodiment, the screw disassembly device 100 further includes a visual recognition mechanism 70. The visual recognition mechanism 70 is configured to identify a workpiece to guide the driving mechanism 10 to drive the electric screwdriver 30 to move toward the workpiece. It will be appreciated that in other embodiments, the visual recognition mechanism 70 may be omitted.

When the screw disassembly device 100 is in use, the visual recognition mechanism 70 detects that the workpiece on the conveying line is in place. The mobile driving member 14 drives the electric screwdriver 30 to move toward the conveying line. The head portion 34 passes through the clearance hole 543 through the transfer block 54 and then disassembles the screw. When the screw is disassembled, the screw is adsorbed to the magnetic head portion 34. The head portion 34 retracts through the clearance hole 543. The stripping driving member 521 drives the two clamping blocks 523 to move toward each other to clamp the screw, and the screw is separated from the head portion 34 as the head portion 34 continues to retract. The vacuum generator is activated to generate a negative pressure in the receiving box 56, the stripping driving member 521 drives the two clamping blocks 523 to move away from each other to release the screw, and the screw is sucked by the negative pressure through the transfer tube 561 into the receiving box 56.

The collecting mechanism 50 separates the screw from the head portion 34, and then the screw is sucked into the receiving box 56 through the transfer tube 561. Thus, the screws are not easily lost, and no additional time is required to retrieve the disassembled screws, thereby increasing efficiency.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A screw disassembly device comprising:
a driving mechanism;
an electric screwdriver; and
a collecting mechanism; wherein:
the driving mechanism is coupled to the electric screwdriver to drive the electric screwdriver to move;
the electric screwdriver is configured to disassemble a screw and comprises a head portion;
the head portion is configured to adsorb the screw;
the collecting mechanism comprises a stripping member, a transfer block, a receiving box, and a transfer tube;
the transfer block is mounted on the driving mechanism;
the transfer block defines a transfer chamber;
the head portion of the electric screwdriver movably passes through the transfer block and the transfer chamber of the collecting mechanism;
the stripping member is configured to clamp the screw within the transfer chamber to remove the screw from the head portion;
an inner chamber of the receiving box is coupled to the transfer chamber by the transfer tube; and
the receiving box is adapted to generate a negative pressure to draw the screw through the transfer tube into the receiving box.

2. The screw disassembly device of claim 1, wherein:
the stripping member comprises a stripping driving member and two clamping blocks;
the stripping driving member is mounted on the driving mechanism;
an end of each of the two clamping blocks is mounted to the stripping driving member, and a second end of each of the two clamping blocks is configured to movably enter the transfer block;
the two clamping blocks are driven by the stripping driving member to clamp the screw.

3. The screw disassembly device of claim 1, wherein:
the driving mechanism comprises a mounting plate, a mobile driving member, and a connecting block;
the mobile driving member and the transfer block are mounted on the mounting plate;
the connecting block is mounted on an output shaft of the mobile driving member;
the electric screwdriver is mounted on the connecting block.

4. The screw disassembly device of claim 3, wherein:
the driving mechanism comprises a sliding rail mounted on the mounting plate;
the connecting block is slidably mounted on the sliding rail.

5. The screw disassembly device of claim 4, wherein:
the connecting block comprises at least one protruding portion;
the driving mechanism comprises at least one stopping block mounted on the mounting plate;
the at least one stopping block is configured to stop the at least one protruding portion to limit a maximum course of movement of the electric screwdriver.

6. The screw disassembly device of claim 1 further comprising a visual recognition mechanism configured to recognize a workpiece to guide the driving mechanism to drive the electric screwdriver to move.

7. The screw disassembly device of claim 1, wherein:
the transfer block defines a clearance hole passing through the transfer block;
the clearance hole is in communication with the transfer chamber;
the electric screwdriver is configured to pass through the clearance hole to disassemble the screw or transfer the screw into the transfer chamber.

8. A collecting mechanism configured to collect screws disassembled by an electric screwdriver comprising a head portion, the collecting mechanism comprising:
a stripping member;
a transfer block;
a receiving box; and
a transfer tube; wherein:
the transfer block is arranged between the electric screwdriver and the screw to be disassembled;
the transfer block defines a transfer chamber;
the stripping member is configured to clamp the screw within the transfer chamber to remove the screw from the head portion;
an inner chamber of the receiving box is coupled to the transfer chamber by the transfer tube; and
the receiving box generates a negative pressure to draw the screw through the transfer tube into the receiving box.

9. The collecting mechanism of claim 8, wherein:
the stripping member comprises a stripping driving member and two clamping blocks;
the stripping driving member is mounted on the driving mechanism;
an end of each of the two clamping blocks is mounted to the stripping driving member, and a second end of each of the two clamping blocks is configured to movably enter the transfer block;
the two clamping blocks are driven by the stripping driving member to clamp the screw.

10. The collecting mechanism of claim 8, wherein:
the transfer block defines a clearance hole passing through the transfer block;
the clearance hole is in communication with the transfer chamber;
the electric screwdriver is configured to pass through the clearance hole to disassemble the screw or transfer the screw into the transfer chamber.

11. A driving mechanism configured to drive an electric screwdriver to move to disassemble a screw, the driving mechanism comprising:
a mounting plate;
a mobile driving member; and
a connecting block; wherein:
the mobile driving member is mounted on a mounting plate;
the connecting block is mounted on an output shaft of the mobile driving member; and
the electric screwdriver is mounted on the connecting block.

12. The driving mechanism of claim 11, further comprising a sliding rail mounted on the mounting plate; wherein the connecting block is mounted on the sliding rail.

13. The driving mechanism of claim 11, wherein the driving mechanism is guided by a visual recognition mechanism configured to recognize a workpiece to guide the driving mechanism to drive the electric screwdriver to move.
